(19) United States
(12) Patent Application Publication
(10) Pub. No.: US 2004/0218670 A1
(43) Pub. Date: Nov. 4, 2004

(54) Method and apparatus for reducing the bandwidth required for transmitting video data for display

(76) Inventors: Jimmy Kwok Lap Lai, Vancouver (CA); Barinder Singh Rai, Surrey (CA)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/428,741

(22) Filed: May 2, 2003

(51) Int. Cl. H04N 7/12

(52) U.S. Cl. 375/240.01

(57) ABSTRACT

The invention is directed to a method and apparatus for reducing the bandwidth required for transmitting video data for display. The invention operates on data that is adapted for presentation to a memory at a refresh rate in the form of successive video frames. Each respective video frame represents a predetermined number of pixels of a display device. In addition, each respective pixel is updated by the video frames according to changes in the video data. The method comprises sampling the video data such that, for at least one of the video frames, more than zero and less than 100% of the pixels are updated.

### FIELD OF THE INVENTION

The present invention relates generally to image processing, and more particularly to a method and apparatus for reducing the bandwidth required for transmitting video data for display.

### BACKGROUND OF THE INVENTION

In a traditional motion picture or movie, a series of images are projected on a screen in rapid succession. Objects appear to move in a motion picture if in each successive image the object is shown in a position that is slightly changed from its previous position. The term “frame” was probably first used in connection with motion pictures to describe the individual images on the strip of photographic film through which light is projected to create a movie. The frames in a motion picture must be projected at a minimum rate in order to produce objects in the image that appear to move realistically. Like a traditional movie, television produces images with objects that move. As with a movie, this is accomplished by projecting a sequence of frames in rapid succession. However, television images are created electronically, not with film. Originally, the television video frame was created with an analog signal. Subsequently, it became possible to create television-type video frame with a digital signal. While digital television has yet to be widely adopted, digital video is coming into widespread use in other applications.

Digital video typically begins with a digital video camera capturing a sequential stream of individual frames at a rate that is typically 24 to 30 frames per second. The rate at which video frames are captured is usually referred to as the frame rate. The size of a frame varies, but 720×480 pixels is one common frame size. In digital video display and capture systems, the video frames are transferred to a video capture circuit where they are processed and then stored in a memory. The rate at which video frames are written to memory is usually referred to as the memory refresh rate. The video image may be viewed on a display device by reading the frames from the memory and then presenting them to a display device. The frames are typically read by a display controller circuit that process the frames for display and presents them to a display device where they are sequentially displayed. A display controller typically refreshes the display device with video data 60 to 70 times per second. The rate at which video frames are presented to the display device is usually referred to as the display refresh rate.

It will be appreciated that an immense amount of video data is required to display a video image on a display device. For instance, each frame in a video with a resolution of 720×480 has 345,600 pixels. Over 8 million bits of data are required to represent a single image if each pixel is represented by a 24 bit data word. At 24 frames per second, almost 200 million bits of data are sent from a digital video camera to a video capture circuit every second. Given this framework, it is readily apparent that the transmission of digital video data requires a tremendous amount of transmission capacity or bandwidth. The large bandwidth required to transmit video data is a significant problem. It is a problem when video frames are transmitted from the video source to the video capture circuit, from the video capture circuit to the memory, from the memory to the display controller, and from the display controller to the display device. A problem related to this substantial requirement for bandwidth is that transmitting video data requires large amounts of power. This in turn generates heat and, in battery operated systems, shortens battery life.

Cellular telephones and hand-held organizers have come into widespread use. A recent trend is that these devices are now being made available with built-in video cameras and one or more display devices capable of displaying video images. Further, it is becoming increasingly feasible to transmit video images from other video sources to these devices for display. However, the large bandwidth required to transmit video data, the heat generation, and the short battery life is a particularly acute problem in these devices. An additional problem in battery powered devices is that many do not give any warning when the battery is running low or do not take steps to conserve power when battery life is running low, or both. Many devices continue to drain the battery at the full rate until the device abruptly fails without warning when the battery is fully exhausted.

One way to address the bandwidth problem is to compress the video data before transmitting it. Upon receipt, the video data is decompressed so that it can be displayed. The Motion Pictures Experts Group (MPEG) has adopted several widely used video compression techniques. While compression schemes can be effective, they are complicated and require additional hardware, software, or both. In addition, it takes time and CPU resources to compress and decompress video data. A further problem with compression techniques results from the fact that most are “lossy,” that is, some information is permanently lost when the video data is compressed. Lossy compression techniques work well for some types of images, but typically do not do a good job of reproducing images of text.

Another possible method for addressing the bandwidth problem is simply to not transmit all of the frames captured by the video source. However, dropping frames results in a video image in which objects move with abrupt and jerky motions. The video image is unrealistic looking and viewing it may result in eye strain.

Accordingly, there is a need for a method and apparatus for reducing the bandwidth required for transmitting video data for display that does not need complicated hardware or software, such as that associated with compression schemes, and that does not produce unrealistic video images, such as that associated with dropping frames. Such a method or apparatus would be especially beneficial in battery powered devices if it was adapted to help manage battery life or provide an indication when the energy remaining in a battery is running low.

### BRIEF SUMMARY OF THE INVENTION

The invention is directed to a method and apparatus for reducing the bandwidth required for transmitting video data for display. The invention operates on data that is adapted for presentation to a memory at a refresh rate in the form of successive video frames. Each respective video frame represents a predetermined number of pixels of a display device. In addition, each respective pixel is updated by the video frames according to changes in the video data corresponding to the pixel. The method comprises sampling the video data such that, for at least one of the video frames, more than zero and less than 100% of the pixels are updated.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a block diagram of a system having a video memory according to the present invention.

FIG. 2 illustrates an exemplary frame of video data stored in the video memory of FIG. 1.

FIG. 3 illustrates an exemplary frame of video data stored in the video memory of FIG. 1 according to the present invention.

FIG. 4 illustrates another exemplary frame of video data stored in the video memory of FIG. 1 according to the present invention.

FIG. 5 illustrates how diagonal rows may be interleaved in the exemplary frame of video data of FIG. 4 according to the present invention.

FIG. 6 illustrates successive exemplary frames of video data in which the same pixels are sampled in each frame according to an alternative embodiment of the present invention.

FIG. 7 illustrates successive exemplary frames of video data in which complementary groups of pixels are sampled in four successive frames according to an alternative embodiment of the present invention.

FIG. 8 illustrates successive exemplary frames of video data in which groups of horizontally and vertically adjacent pixels are sampled according to an alternative embodiment of the present invention.

FIG. 9 illustrates successive exemplary frames of video data in which 100% of the pixels are sampled in alternate frames and less than 100% of the pixels are sampled in the remaining frames according to an alternative embodiment of the present invention.

FIG. 10 illustrates successive exemplary frames of video data in which more than 50% of the pixels are sampled in each frame according to an alternative embodiment of the present invention.

### DETAILED DESCRIPTION OF A PREFERRED EMBODIMENT

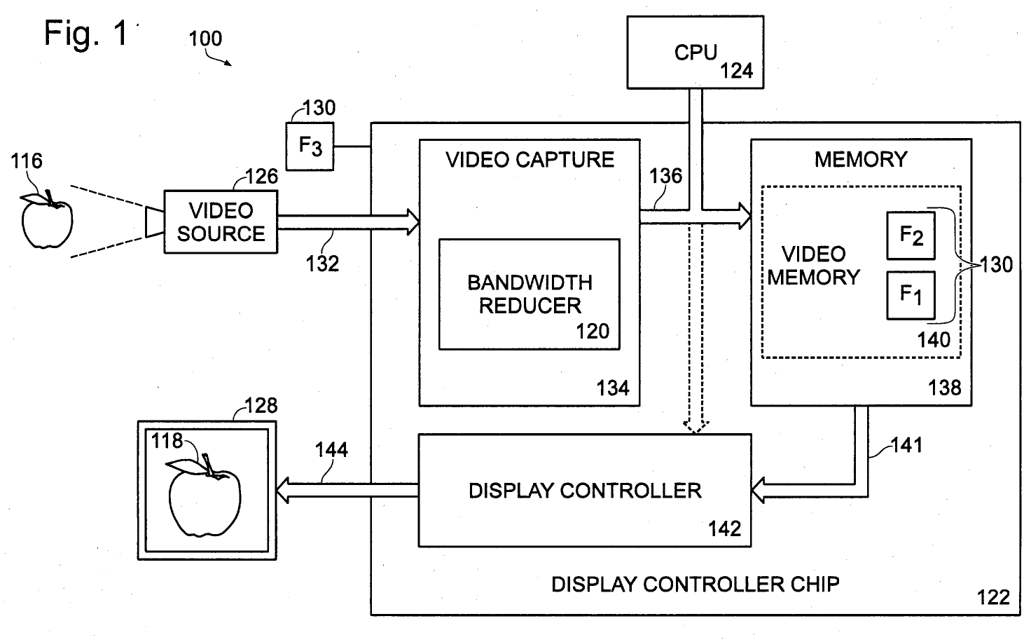

The present invention is directed to a method and apparatus for reducing the bandwidth required for transmitting video data for display. FIG. 1 is a block diagram of a system 100 illustrating a preferred embodiment of a bandwidth reducer 120 according to the present invention. It should be recognized that the invention is not limited in scope to this particular embodiment. The system 100 includes a display controller integrated circuit (“chip”) 122, a CPU 124, a video source 126, and a display device 128. The video source captures video data for an object 116 and an image 118 of the object 116 is displayed on the display device 128.

Video data is captured by the video source 126 as a series of individual video frames F₁, F₂, F₃ . . . F_{N}, collectively referred to by reference number 130. The video source 126 commonly has an internal memory with the capacity to hold at least one video frame 130. The video data is transmitted on a video bus 132 to a video capture circuit 134 within the display controller chip 122. The video capture circuit 134 processes the video frames 130 and then transmits them on a memory bus 136 to a memory 138 where they are stored in a part of the memory reserved for video data and referred to as a video memory 140. Typically, the video memory 140 has the capacity to hold two video frames 130 so that one frame may be written to the memory while another is available to be read out. A display controller circuit 142 reads the stored video frames 130 from the memory 138 via a display controller bus 141, processes them, and then presents the video frames 130 over a display bus 144 to the display device 128 where they are sequentially displayed. The CPU 124 is coupled to the display controller chip 122 and may read from or write to the memory 138 over the memory bus 136.

Video data, generally speaking, consists of a series of video frames 130. With reference to the present invention and the system 100, a video frame refers to any computer readable representation of an image 118. A video frame may consist of a rectangular array of pixels representative of an image 118 at a particular instant in time, or it may consist of block of binary data which defines the values of the pixels (“digital video frame”). In the case of a digital video frame, each pixel is represented by a binary number that is typically 1, 8, 16, 24, or 32 bits in length. For instance, a single bit is used to represent a pixel in a bi-level video image, an image in which the pixels can only take black (off) or white (on) values. Use of a single bit to represent a pixel, however, is not common. In a typical color image, each pixel is represented by a 24- or 32-bit data word. In addition, a digital video frame can represent the image in a number of different ways. For example, the video frame may be a raster sequence of data words that have a one-to-one correspondence with the pixels in the display device. Alternatively, the data words in the video frame may be arranged in some other sequence. Further, the digital video frame may comprise several sub-frames, with each sub-frame having a plurality of data words representing one component of each of the pixels included in the video frame. In summary, it will be recognized that as video data moves through system 100 from the video source 126 to the display device 128, the video data may take any form of any known computer readable representation. Similarly, it will be appreciated that the teachings of the present invention may be practiced on any known computer readable representation of video data.

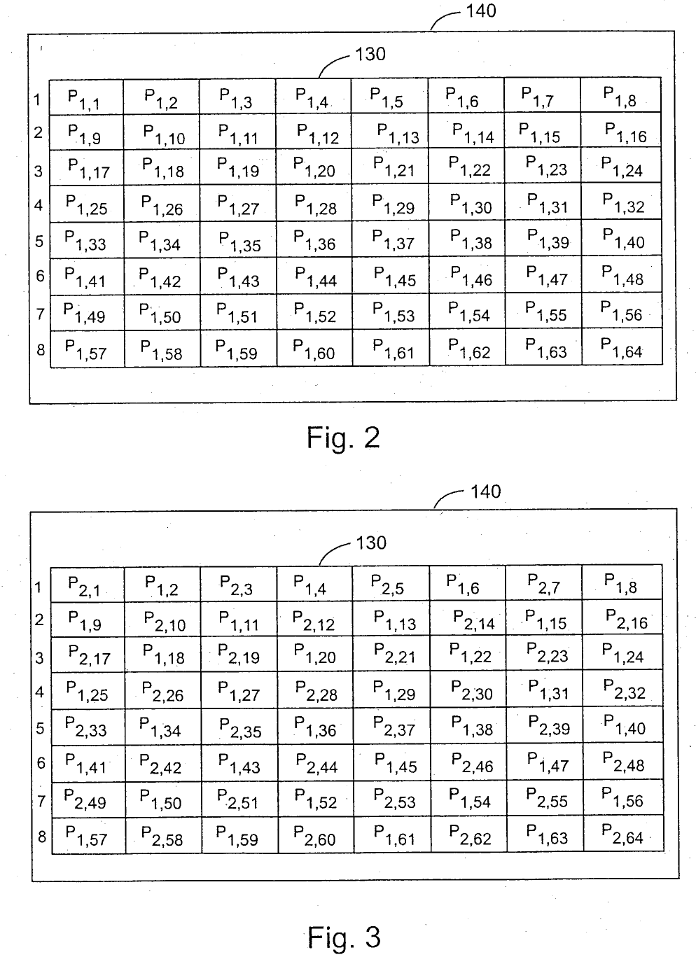

FIG. 2 illustrates one exemplary 8×8 digital video frame 130 of pixels stored in the video memory 140. Each pixel is assigned a number from 1 to 64 and the pixels are ordered in raster sequence. The first subscript denotes the frame number and the second denotes the pixel number. Thus, the shown frame is a first frame: F₁. As an example, the pixel P_{1,3} refers to the third pixel in the first frame. As mentioned, the video data need not be represented as a frame of pixels at any stage of the system 100, however, it is useful for understanding the operation of the present invention if the video data is considered as an array of pixels. Hence, the video data will be referred to as frames of pixels in the description of the embodiments of the invention that follow.

FIG. 1 also presents a view at a particular point in time of a series of video frames 130. It can be seen that the frames 130 created at different points in time are at different stages in the system 100 at any particular point in time. For purposes of illustration, the video frames 130 are considered to be created in the order with which they are numbered. The first frame F₁ is read from video memory 140 by the display controller 142, processed, and presented to the display device 128. At the same time, the second frame F₂ is received by the capture circuit 142, processed, and stored in the video memory 140. Simultaneously, the third frame F₃ is being captured by the video source 126. As with the pictures on a strip of photographic film, the video frames in the system 100 evolve with time according to the movement (or other changes, such as the color) of the objects in the image. In particular, each pixel evolves according to changes in the video data.

Referring again to FIG. 1, the memory bus 136 in the system 100 has a finite bandwidth. The memory bus 136 is shared by the video capture circuit 134 and the CPU 124. The bandwidth of the memory bus 136 may be insufficient to provide both the video capture circuit 134 and the CPU 124 with all of the bandwidth that each circuit requires. The bandwidth reducer 120 operates to reduce the amount of bandwidth that the video capture circuit 134 requires.

In known video capture and display systems, the video data is presented in successive video frames 130 to the video memory 140 at a memory refresh rate. Each respective video frame 130 represents in the display device 128 a predetermined number of pixels. Further, each respective pixel in the display device 128 is updated by the video frames according to changes in the video data that correspond to the pixel at a display refresh rate.

In contrast, and according to the present invention, the bandwidth reducer 120 samples the video data and causes the sampled video data to be presented in video frames 130 to the video memory 140. In particular, the bandwidth reducer 120 causes the video capture circuit 134 to store as a next sequential video frame 130 in the video memory 140 only the sampled video data. The sampling is performed such that more than zero and less than 100% of the pixels are written to the video memory 130 at the memory refresh rate.

FIGS. 2-4 illustrate digital video frames according to a first preferred exemplary sampling method according to the present invention. FIG. 2 shows a first digital video frame F₁ in a sequence of video frames 130 as having been transferred in its entirety and stored in video memory 140. Every pixel in the first frame F₁ sent by a video source 126 is sampled and written to memory in the same manner as in known methods. The video frame F₁ as it is shown in FIG. 2 will be read by the display controller 142, processed, and written to the display device 128 as a first successive frame of the displayed video image 118. In each subsequent successive frame 130 that is displayed, however, according to the present invention, fewer than all of the pixels in the frames 130 sent by the video source 126 are sampled and only the sampled pixels are written to video memory 140.

FIG. 3 shows how the video memory 140 looks after a next digital video frame F₂ has been sampled and written to memory 140. As can be seen from FIG. 3, according to the first preferred exemplary sampling method, odd numbered pixels on odd numbered lines have been sampled and stored in the video memory 140. In addition, even numbered pixels on even numbered lines have been sampled and stored in the video memory 140. For example, on the first odd line 1, the bandwidth reducer 120 has sampled pixels P_{2,1}, P_{2,3}, P_{2,5}, and P_{2,7}. And, on the first even line 2, the bandwidth reducer 120 has sampled pixels P_{2,10}, P_{2,12}, P_{2,14}, and P_{2,16}.

Referring to FIG. 3, the video frame 130 will be read by the display controller 142, processed, and written to the display device 128 as a second consecutive frame 130 in the displayed video image 118. It will be recognized, however, that the video frame 130 shown in FIG. 3 includes video data from both the first and second successive frames F₁ and F₂ sent by the video source 126. Specifically, the video frame 130 shown in FIG. 3 includes the even numbered pixels on odd numbered lines from frame F₁, as for example, P_{1,2}, P_{1,4}, P_{1,6}, and P_{1,8} on odd line number 1 as well as the odd numbered pixels on even numbered lines from frame F₁, such as, P_{1,3}, P_{1,11}, P_{1,3}, and P_{1,15} on even numbered line 2. Further, the video frame 130 shown in FIG. 3 includes pixels from the frame F₂, such as P_{2,1}, P_{2,3}, P_{2,5}, and P_{2,7} and P_{2,10}, P_{2,12}, P_{2,14}, and P_{2,16}.

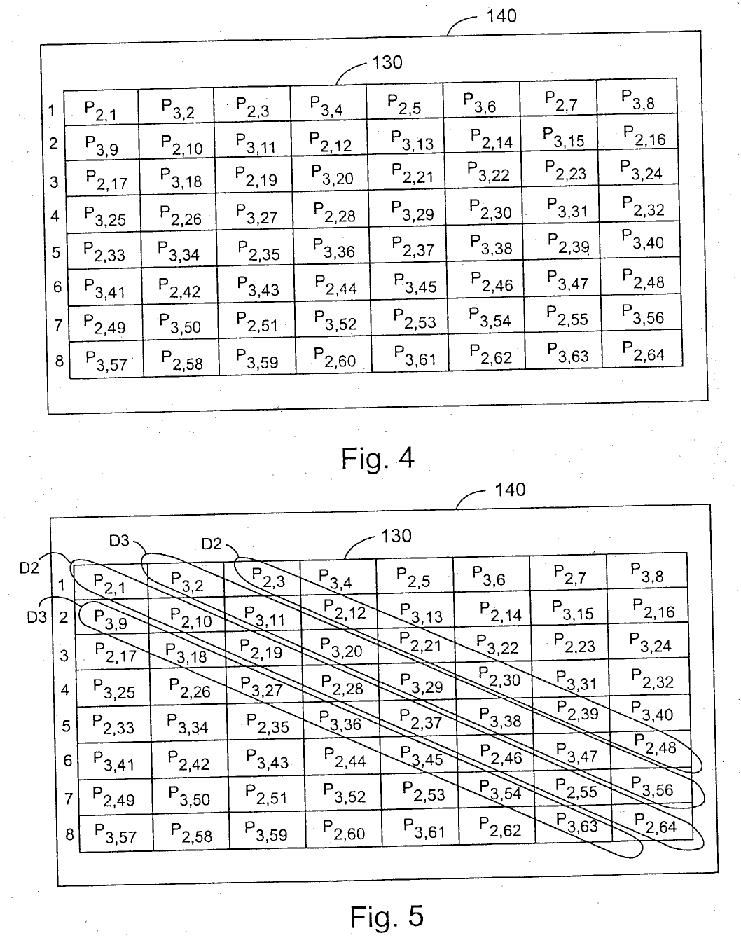

FIG. 4 continues the illustration of the first exemplary sampling method, showing how the video memory 140 looks after a third successive frame F₃ has been sent from the video source 126, sampled, and written to video memory 140. As can be seen from FIG. 4, the third frame F₃ is sampled in a manner that complements the sampling of the second frame F₂, that is, the sample of the frame F₃ includes every pixel that was not sampled from the sample of the frame F₂. Moreover, the sample of the frame F₃ includes no pixel that was sampled from the sample of the frame F₂. FIG. 4 shows that even numbered pixels on odd numbered lines and odd numbered pixels on even numbered lines are sampled from frame F₃ and stored in the video memory 140. The video frame 130 as it is shown in FIG. 4 will be read by the display controller 142, processed, and written to the display device 128 as a third successive frame in the displayed video. It will again be recognized that the video frame 130 shown in FIG. 4 again includes a blend of data from two frames. In particular, the third successive frame that the display controller will read includes video data from the second and third frames F₂ and F₃. For example, on the first line 1, pixels P_{2,1}, P_{2,3}, P_{2,5}, and P_{2,7} from frame 2 and pixels P_{3,2}, P_{3,4}, P_{3,6}, and P_{3,7} from frame 3 are presented to the display device 128.

The bandwidth reducer 120 continues sampling according to the first exemplary sampling method described above as additional frames are presented by the video source 126 to the video capture circuit 134. According to the first exemplary sampling method, the pixels sampled from alternate frames are complementary, that is, 100% of the pixels are sampled in two consecutive frames. Thus, for frame F₄, odd numbered pixels on odd numbered lines and even numbered pixels on even numbered lines will be sampled and stored in the video memory 140. And, for frame F₅, even numbered pixels on odd numbered lines and odd numbered pixels on even numbered lines will be sampled and stored in the video memory 140. It will be appreciated that the exemplary sampling method illustrated in FIGS. 2-4 reduces by half the bandwidth required to transmit the video data 130 for each frame subsequent to the first frame F₁.

FIG. 5 shows that the first exemplary sampling method produces video frames stored in video memory 140 that are interleaved on diagonal lines. In FIG. 5, the encircled areas D2 show how the pixels that were sampled from frame F₂ are arranged in alternating layers on diagonal lines. Similarly, the encircled areas D3 shows how the pixels that were sampled from frame F₃ are arranged in alternating layers on a diagonal lines. It can be seen that the encircled diagonals D2, D3 are arranged in alternating layers.

According to the first exemplary sampling method, the pixels are sampled uniformly throughout the video frame 130 and pixels that are horizontally or vertically adjacent are not sampled in the video frame. Further, 50% of the pixels are updated in every video frame 130 and every pixel is updated in alternate frames. It will be appreciated that the use of a uniform sampling pattern of complementary interleaved groups of pixels that comprise 50% of the pixels in the video frame 130 can result in an image on the display device 128 that appears substantially the same as an image produced from video data that has not been sampled. Of course, the degree with which the image produced with sampled video data departs from one produced without sampling depends on the video data. Many times, objects in the image are stationary or move slowly. Such objects may comprise all or a substantial part of the image. Thus, it will be appreciated that the present invention when practiced according to the first exemplary sampling method will frequently produce video images in which the fact that the image was produced with sampled data will be imperceptible.

It should be recognized that that the invention is not limited in scope to the first exemplary sampling method described above. It is not essential to the invention that the video data be sampled in such a manner that the fact of sampling is imperceptible when the video data is viewed. The video data may be sampled in a manner such that the fact of sampling is perceptible when the video data is viewed. The less than perfect visual presentation of the sampled video data may be such that it is acceptable to the user or it may be used to provide visual cue of remaining battery life, or both.

For certain video data, it may be that updating complementary groups numbering one sixtieth of the pixels in each of every 60 successive frames would provide an acceptable video image 118. Such a sampling method would typically update every pixel on a display device 128 once every second. Indeed, updating groups of 1/120^{th} of the pixels or more in each of every 120 successive frames may be acceptable, depending on how the video data evolves. In other circumstances, updating complementary groups numbering 59/60^{ths} or an even greater fraction of the pixels in each of every 60 successive frames may be desired. A sampling method wherein high percentages of pixels are updated may be desired for certain video data that evolves rapidly while still affording a measure of bandwidth and power savings. Thus, it will be appreciated that any sampling method providing for updating of successive frames with more than zero and less than 100% of the pixels would not depart from the principles of the present invention.

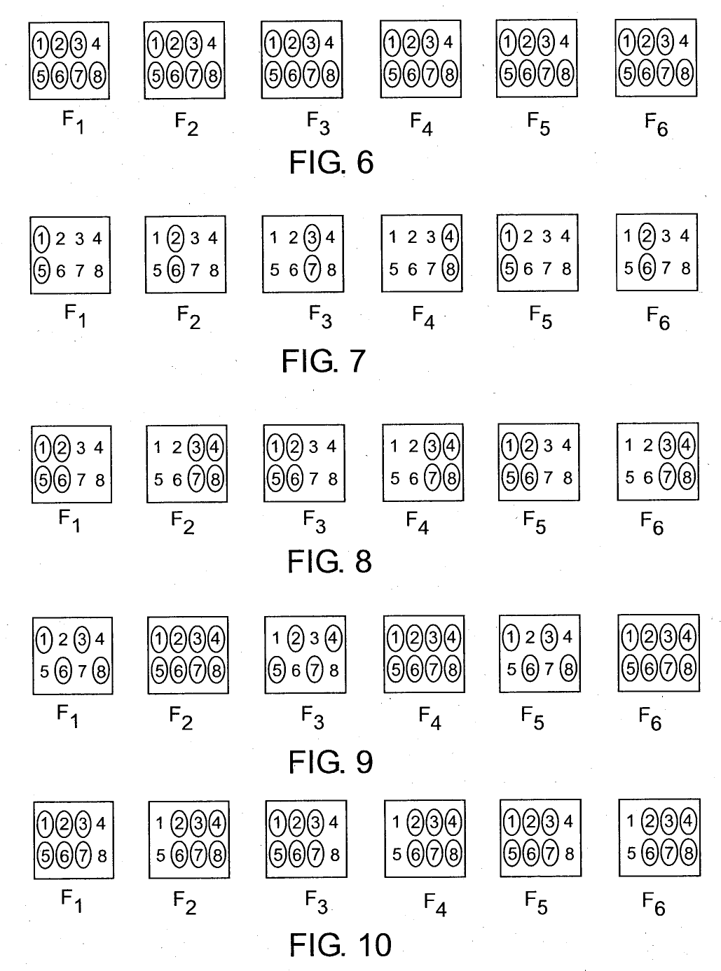

FIGS. 6 to 10 show alternate exemplary sampling methods. FIGS. 6 to 10 each illustrate a sequence of successive digital video frames F₁ to F₆ having only 8 pixels (numbered 1-8) that could be displayed on a simplified display device 128. The frames F₁ to F₆ are frames 130 that would be stored in a video memory 140 for presentation to a display device 128. It is assumed that a video source 126 sends similar 8-pixel frames (not shown) to a video capture circuit 134 having a bandwidth reducer 120. Each pixel that is updated as a result of being sampled from a frame 130 sent by a video source 126 is circled. It will be appreciated that the exemplary sampling methods illustrated in FIGS. 6 to 10 could be employed for frames having any number of pixels.

FIG. 6 illustrates successive exemplary frames 130 in which the same pixels are sampled in each frame according to an alternative embodiment of the present invention. It can be seen from FIG. 6 that the same pixels (1, 2, 3, 5, 6, 7, 8), representing 88% of the video frame 130, are updated in each successive video frame and that the pixel 4, representing 12% of the video frame 130, is not updated. Depending on the video data, when the video data is viewed on the display device 128, generally, part of the image will appear as a normal digital video image and part of the image will not change, that is, it will appear to “freeze.”

According to the present invention, it is recognized that it is generally preferable, unless some information is known about how the video data evolves from frame to frame, to update all of the pixels in the video frame 130 at the same rate. The exemplary sampling method shown in FIG. 6 might be employed when information is known about how the video data evolves from frame to frame or in circumstances when it is deemed acceptable to permit a part of the image to be frozen. For instance, the freezing of a part of the displayed image may represent a visual cue to a user that particular amount of battery life remains.

FIG. 7 illustrates successive exemplary frames in which complementary groups of pixels are sampled from four successive frames according to an alternative embodiment of the present invention. In the sampling method shown in FIG. 7, 100% of the pixels are sampled from four successive video frames 130 presented by the video source 126. The pixels 1 and 5, 2 and 6, 3 and 7, and 4 and 8 are updated, respectively, in the frames F₁, F₂, F₃, and F₄ that will be presented to the display device 128.

In the first exemplary sampling method, complementary groups of pixels are sampled in alternate video frames 130. In contrast, in the exemplary sampling method shown in FIG. 7, complementary groups of pixels are sampled from four successive video frames 130. While it is generally preferable that complementary groups of pixels be sampled from alternate frames, it will be appreciated that it is not essential to the present invention. Complementary groups may be sampled from any number of video frames 130.

FIG. 8 illustrates successive exemplary frames in which groups of horizontally and vertically adjacent pixels are sampled according to an alternative embodiment of the present invention. In FIG. 8, the pixels (1, 2, 5, 6) are updated in a first video frame F₁ and the pixels (3, 4, 7, 8) are updated in a second video frame F₂. The pixels (1, 2, 5, 6) are horizontally and vertically adjacent as are the pixels (3, 4, 7, 8).

In the first exemplary sampling method, the pixels sampled in alternate video frames 130 are neither vertically nor horizontally adjacent. That is, according to the first exemplary sampling method, the pixels 1, 3, 6, and 8 would be updated in a first frame F₁ of the, 8 pixel frames of FIGS. 6 to 10. In a second frame F₂, the pixels 2, 4, 5, and 7 would be updated. For example, pixel 1 is horizontally adjacent to pixel 2 and vertically adjacent to pixel 5 and pixel 1 is updated in frame F₁, but pixels 2 and 5 are updated in frame F₂. Another way of saying that the pixels sampled in alternate video frames 130 are neither vertically nor horizontally adjacent is to say that that alternate frames are interleaved in video memory 140 on diagonal lines of pixels. In contrast, in the exemplary sampling method shown in FIG. 7, alternate frames are not interleaved in video memory 140 on diagonal lines of pixels. While it is generally preferable to interleave pixels from alternate frames on diagonal lines, such interleaving is not essential to the present invention.

FIG. 9 illustrates successive exemplary frames in which 100% of the pixels are sampled in alternate frames and less than 100% of the pixels are sampled in the remaining frames according to an alternative embodiment of the present invention. In frame F₁, a first group of pixels (1, 3, 6, 8) are updated. In frame F₂, a second group of pixels (1, 2, 3, 4, 5, 6, 7, 8) are updated. In frame F₃, a third group of pixels (2, 4, 5, 7) are updated. In frame F₄, the second group of pixels is updated. The second group includes 100% of the pixels in the frame. The first and third groups are complementary.

In the first exemplary sampling method, the group of pixels updated in each successive video frame 130 is always less than 100% of the pixels in a frame. While a sample of less than 100% is generally preferably, it is not essential that less than 100% of the pixels be updated in each video frame 130. FIG. 9 illustrates an exemplary embodiment along these lines that would generally yield a high quality video image 118 while still producing a substantial savings in memory bandwidth.

FIG. 10 illustrates successive exemplary frames in which more than 50% of the pixels are sampled in each frame according to an alternative embodiment of the present invention. Some, but not all, of the same pixels are updated in alternate successive frames. That is, some of the updated pixels overlap. In frame F₁, a first group of pixels (1, 2, 3, 5, 6, 7) representing 75% of the pixels are updated. In frame F₂, a second group of pixels (2, 3, 4, 6, 7, 8) also representing 75% of the pixels are updated. The pixels 2, 3, 6, and 7 are overlapping pixels in that they are updated in each successive frame. The pixels 1 and 5, and 4 and 8 are non-overlapping pixels in that they are updated in alternate frames.

In the first exemplary sampling method, none of the pixels updated in each successive video frame 130 overlap. While it is generally preferable to not overlap pixels that are updated in alternate frames, it is not essential to the present invention that such overlapping be avoided. Like the embodiment of FIG. 9, the embodiment of FIG. 10 would yield a high quality video image 118, while still producing a substantial savings in memory bandwidth.

As the alternative sampling methods described above illustrate, the present invention may be practiced in a variety of different ways. Additional alternative sampling methods will be apparent to one of ordinary skill in the art.

The bandwidth reducer 120 preferably samples the video data at the same stage as the video capture circuit 134. As such, the bandwidth reducer 120 is shown in FIG. 1 as a component within the video capture circuit 134. It should be appreciated, however, that the invention may advantageously be employed for any transmission of video data and not just with respect to the writing of video data by a video capture circuit 134 to a video memory 140. For example, the bandwidth reducer 120 may advantageously sample video data provided by the video source 126 before such data is placed on the video bus 132. As a second example, the bandwidth reducer 120 may advantageously sample video data before or after the display controller circuit 142.

It should be appreciated that the invention may advantageously be employed in a variety of systems and not just in system 100. For instance, the system may include a plurality of video sources, video capture circuits, CPUs, memories, display controller circuits, and display devices. Additionally, the memory bus 136 may be directly coupled to the display controller circuit 142, as shown by dashed lines in FIG. 1. Moreover, the video memory 140 may be a dedicated video memory. In addition, the video memory 140 may be a memory located off of the display controller chip 122. It should also be noted that the memory bus 136 may have other devices and circuits than those shown coupled to it.

One aspect of the present concept is that it may be user controlled. A display device 128 can be used to view a variety of types of content. For example, content can be static images such as text or images, or dynamic images such as video. The invention may result in an image that a user perceives as acceptable for certain types of content, but that is considered unacceptable for other types of content. The user may choose to not limit memory bandwidth according to the invention if the user desires a higher quality image. In this case, the performance of other functions performed by the computer system (that require access to the memory) may be degraded, but the user may choose to make this tradeoff. Alternatively, the user may choose to limit the memory bandwidth used for displaying an image so that other functions used by the computer system are not degraded. In this case, the displayed image may be deemed acceptable by the user in order that the other functions may be performed without degradation.

It is desirable that system 100 fail “gracefully” when the power supply is exhausted. The invention may be used as a means for the system 100 to fail gracefully. Accordingly, the bandwidth reducer 120 may be automatically activated when the remaining charge in a battery reaches a predetermined level. While the user would still be able to view an acceptable displayed image, the displayed image would show some diminishment in quality as a visual cue. When the remaining charge in the battery reached a second predetermined level, a level lower than the first, the bandwidth reducer 120 would switch to a sampling rate that provided greater bandwidth savings and an image of even lesser quality. However, the user would still be able to view an acceptable displayed image. This would provide important visual feedback to a user that battery was getting low. This aspect of the invention is not limited to a traditional battery, but may be applied with respect to any exhaustible power supply. A fuel cell is one example of another type of an exhaustible power supply.

In addition, the concept has been described in terms of writing pixel values to a video memory. While pixel values represent a preferred context for the invention, the bandwidth reducer 120 may be used with any type of data samples that are organized in frames or in a similar manner.

The terms and expressions that have been employed in the foregoing specification are used as terms of description and not of limitation, and are not intended to exclude equivalents of the features shown and described or portions of them. The scope of the invention is defined and limited only by the claims that follow.

1. A method for reducing memory bandwidth requirements for transmitting video data for display, the data being adapted for presentation to a memory at a refresh rate in the form of successive video frames, each respective video frame representing a predetermined number of pixels of a display device, and each respective pixel being updated according to changes in the video data corresponding to the pixel by the video frames, the method comprising sampling the video data such that, for at least one of the video frames, more than zero and less than 100% of the pixels are updated.

2. The method of claim 1, wherein, for at least two of said video frames, at least some of the same pixels are not updated.

3. The method of claim 1, wherein, for at least two of said video frames, the same pixels are not updated.

4. The method of claim 2, wherein said at least two video frames are consecutive video frames.

5. The method of claim 3, wherein said at least two video frames are consecutive video frames.

6. The method of claim 3, wherein, for N consecutive frames where N is an integer, 100/N % of the pixels are updated by each of said at least two video frames.

7. The method of claim 6, where N=2, so that 50% of the pixels are updated by each of said at least two video frames.

8. The method of claim 6, wherein the pixels in said N frames are interleaved.

9. The method of claim 7, wherein the pixels in said N frames are interleaved.

10. The method of claim 9, wherein the method is performed as a result of determining that a particular level of energy remains in an exhaustible power supply.

11. The method of claim 9, wherein the method is performed as a result of a selection made by a user.

12. A machine readable medium embodying a program of instructions for execution by a machine to perform a method for reducing memory bandwidth requirements for transmitting video data for display, the data being adapted for presentation to a memory at a refresh rate in the form of successive video frames, each respective video frame representing a predetermined number of pixels of a display device, and each respective pixel being updated according to changes in the video data corresponding to the pixel by the video frames, the method comprising sampling the video data such that, for at least one of the video frames, more than zero and less than 100% of the pixels are updated.

13. The machine readable medium of claim 12, wherein, for at least two of said video frames, at least some of the same pixels are not updated.

14. The machine readable medium of claim 12, wherein, for at least two of said video frames, the same pixels are not updated.

15. The machine readable medium of claim 13, wherein said at least two video frames are consecutive video frames.

16. The machine readable medium of claim 14, wherein said at least two video frames are consecutive video frames.

17. The method of claim 14, wherein, for N consecutive frames where N is an integer, 100/N % of the pixels are updated by each of said at least two video frames.

18. The method of claim 17, where N=2, so that 50% of the pixels are updated by each of said at least two video frames.

19. The method of claim 17, wherein the pixels in said N frames are interleaved.

20. The method of claim 18, wherein the pixels in said N frames are interleaved.

21. The method of claim 20, wherein the method is performed as a result of determining that a particular level of energy remains in an exhaustible power supply.

22. The method of claim 20, wherein the method is performed as a result of a selection made by a user.

23. An apparatus for reducing memory bandwidth requirements for transmitting video data for display, the data being adapted for presentation to a memory at a refresh rate in the form of successive video frames, each respective video frame representing a predetermined number of pixels of a display device, and each respective pixel being updated according to changes in the video data corresponding to the pixel by the video frames, the apparatus comprising a sampling circuit for sampling the video data such that, for at least one of the video frames, more than zero and less than 100% of the pixels are updated.

24. The apparatus of claim 23, wherein, for at least two of said video frames, at least some of the same pixels are not updated.

25. The apparatus of claim 23, wherein, for at least two of said video frames, the same pixels are not updated.

26. The apparatus of claim 24, wherein said at least two video frames are consecutive video frames.

27. The apparatus of claim 25, wherein said at least two video frames are consecutive video frames.

28. The apparatus of claim 25, wherein, for N consecutive frames where N is an integer, 100/N % of the pixels are updated by each of said at least two video frames.

29. The apparatus of claim 28, where N=2, so that 50% of the pixels are updated by each of said at least two video frames.

30. The apparatus of claim 28, wherein the pixels in said N frames are interleaved.

31. The apparatus of claim 29, wherein the pixels in said N frames are interleaved.

32. The method of claim 31, wherein the method is performed as a result of determining that a particular level of energy remains in an exhaustible power supply.

33. The method of claim 31, wherein the method is performed as a result of a selection made by a user.
